(19) United States
(12) Patent Application Publication
(10) Pub. No.: US 2010/0105811 A1
(43) Pub. Date: Apr. 29, 2010

(54) SEMI-MINERAL PAINT COMPOSED OF THREE AGGLUTINANTS OR FILM-FORMING AGENTS

(76) Inventor: Juan Alsina Vilamala, Arenys de Munt - Barcelona (ES)

Correspondence Address: RICHARD M. GOLDBERG, 25 EAST SALEM STREET, SUITE 419, HACKENSACK, NJ, 07601, US

(21) Appl. No.: 12/520,148

(22) PCT Filed: Feb. 27, 2007
(86) PCT No.: PCT/ES2007/000105

§ 371 Date: Jun. 19, 2009

(30) Foreign Application Priority Data
Feb. 28, 2006 (ES) P200600475

(51) Int. Cl. C08K 3/00; C08L 75/00; C08L 33/00; C08L 63/00

(52) U.S. Cl. 524/5; 524/507; 524/522; 524/502

(57) ABSTRACT

A semi-mineral water-based paint that is virtually inorganic, includes a water-dispersible acrylic copolymer that is elastic and has a low absorption capacity and that is adapted to be mixed with a cement, an emulsion selected from the group consisting of an acrylic, urethane, vinyl and epoxy alkyd modified emulsion, additives, an inert reinforcement filler, colouring pigments, and a cement base if it is in a liquid state, and water if it is in a solid state, such that a manageable paste formed of a putty is obtained that can regulate, paint and decorate at the same time.

The aim of this invention, as expressed in the title of this specification, is a “semi-mineral” water-based paint, virtually inorganic, ecological, made up of three film binding or forming agents. It can overcome the deficiencies, drawbacks and technical limitations of conventional paint.

In the paint sector, the existence and use of mineral paint is well known. The simplest form is whitewash, which once dry and spread over a surface, it decorates and protects said surface, but in the end, disappears quickly.

Also potassium silicate (liquid glass) in German mineral paints are used, according to the silication reaction principle; in other words, said paints achieve extraordinary stability, thanks to the fact that they silificate with the surface. However, they can only be applied to a mineral, non-painted medium, and have no elasticity or plasticity, and they are difficult to clean and sensitive to rising damp and capillary humidity.

At present, the most common paint contains a film (resin or polymer) forming agent as the basic component, and this provides the drying properties, adhesion strength, sufficient resistance and flexibility, preserves its protection and decoration capacity over a long term and facilitates surface repair or renewal, etc.

If we increase the percentage of reinforcement pigments (fillers) in said (resin or polymer) so that the film is manageable with a high covering strength, among other characteristics, there comes a point when the film properties start to diminish, as occurs with Portland cement; the more sand, gravel and water added, the fewer the technical properties.

In the building industry, cements with resins or polymers in powder form are used, once mixed in the same packaging, mainly for mortar glue, and some contain particular additives to avoid any incompatible direct contact between the cement and plaster. They are used to lay mosaics, earthenware tiles, and for plasterboard and wooden tiles, etc.

There are also acrylic and epoxy, water-based, liquid (polymers or resins) intended to be mixed with cement. The acrylic ones have a high percentage of cement, and are used for waterproofing water tanks, canals, basements, interred walls, etc.

In porous, concrete, mortar, stone or brick supports, etc., epoxy resins and polymers are used, thanks to their strength to regulate, level and patch up flooring in general, where carpets, parquet or other finishings have to be laid. At present, paint in general suffers many technical limitations, deficiencies and drawbacks.

Whitewash disappears very quickly, silicate mineral can only be applied to mineral supports, to name just a few of the many limitations.

The most common paint, which contains a film (resin or polymer) forming agent depends, in significant amounts, on the limited percentage of reinforcement pigments (fillers), and the colouring pigments condition its covering ability, elasticity, water absorption and manageability, forming a plastic film that prevents the medium to which it is applied from breathing, thereby causing condensation and blisters if applied to damp surfaces.

The wear and emigration of the (resin or polymer), caused by acid rain, aggressive atmospheres or even UV rays, leave the inert reinforcement pigments (fillers), and the paint colouring pigments exposed, causing highly pollutant air and water emissions, particularly if they contain metal residues such as lead, cadmium, etc.

Furthermore, water-based paint does not have the same application properties or mechanical and chemical strength vis-à-vis solvent, as its counterparts. In adverse weather conditions, such as low temperatures, high humidity, or in closed spaces where air is not renewed, etc., these factors delay or hinder the paint's drying capacity.

Mortar glues, some containing particular additives, are only used for laying mosaics, earthenware tiles, and for plasterboard, wooden tiles etc. Acrylic (polymers or resins) that can mix with cement, are only used for waterproofing porous supports, with a very reduced working time margin and they have no aesthetic qualities, as also occurs with the epoxy ones, which are only used to regulate, level and patch up surfaces.

In order to overcome the technical limitations, deficiencies and drawbacks of paint in general, the novel semi-mineral, water-based paint that is virtually inorganic, ecological, and the object of this specification, includes three film forming agents, a water-dispersible acrylic copolymer that is elastic and has a low absorption capacity (which can be mixed with cement) a), an acrylic, urethane, vinyl or epoxy alkyd modified emulsion b), a cement base c), additives, colouring and reinforcement pigments (fillers).

The paint is available in a liquid state and can be mixed with a cement base. Other products can also be added if other properties are required when the paint is used. It is also available in the solid state and water is added when used.

Adding an acrylic, urethane, vinyl or epoxy alkyd modified emulsion, and the cement base included in the acrylic copolymer, resolves the problem of conventional paint generally known to date, namely, with regard to its dependency on and need for significant quantities of (polymer or resin). The solid cement base acts like a reactive reinforcement pigment (filler), increasing the paint's pH, providing a high content of solids, high chemical and mechanical strength, while preventing the growth of mould and bacteria, and excessive plasticity and condensation caused by the lack of transpiration. Water absorption is virtually zero and the paint retains its elasticity for a long time, thereby allowing protection and waterproofing tasks to be carried out on inside and outside surfaces in general. Furthermore, the film petrifies, preventing the emigration of (resin or polymer) due to acid rain, aggressive atmospheres or UV rays, with a working margin, once mixed with cement, of over two days.

Its drying properties are also altered. It dries at 1° C., and if after application there is an unexpected period of frosty weather, the paint freezes and is polymerised at the same time, without losing any of its properties.

When mixed on site and in use, other previously metered compounds can be mixed, thus reducing the stock and making it possible to produce putties, other colours, or any type of paint; anti-rust paint, thermal paint, intumescent paint, fire resistive paint, acrylic mortar, etc., without tintometric machines being necessary, which leads to a very significant economic saving.

Once mixed using a low revolution mixer, a high density paint is obtained, rich in solids, like putty without sheeting.

It is very easy to apply, using a toothed sizing trowel, a flat trowel, flat short hair brush, alfa brush or putty spray gun, creating a decorative finish.

It also lends itself to other decorative finishes. Using a stainless steel trowel a smooth finish can be obtained, and a foam roller produces a rough, stucco finish, while a plastic roller produces a flattened finish, and a Gotele spray gun sprays coloured sand like an Extolite paint, and a scraper or spatula produce a complete or partial flattened rustic finish. If once mixed, water is added, a fluid paint will be obtained that is to be used with a sponge, chamois leather, spatula, scraper or sprayed with a Gotele gun or applied using conventional tools, roller, brush, gun, etc.

This represents a consequent saving in special putties and also in labour force costs, because the complete thickness can be applied in one go without any long waits between each layer. It is also important to consider the time saved in carrying out the task and the implicit cost saving per metre.

### DESCRIPTION OF THE DRAWINGS

In order to illustrate the above, a series of drawings are attached to this specification, forming an integral part thereof, which merely illustrate an embodiment of the possible implementations of the invention.

In said drawings, FIG. 1 corresponds to the schematic and conceptual diagram of the various components of the new “semi-mineral” water-based paint, that is virtually inorganic, ecological and made up of three film binding or forming agents.

FIG. 2 corresponds to a conceptual view of the arrangement of a vertically painted surface using the new paint.

FIG. 3 corresponds to a conceptual view of the arrangement of a vertically painted surface according to a conventional embodiment, which provides an explanatory comparison of the differences when carrying out the task using the new product.

### DESCRIPTION OF A PRACTICAL EMBODIMENT

The new water-based paint made up of a water-dispersible acrylic copolymer that is elastic and has a low absorption capacity (can be mixed with a cement) (1), an acrylic, urethane, vinyl or epoxy alkyd modified emulsion (2), additives (3), inert reinforcement (filler) and colouring pigments (4), to which, when in used, a cement base is added if it is in a liquid state, or water if it is in a solid state (5), finally obtaining a manageable paste consisting of a putty (6) that can regulate, paint and decorate at the same time.

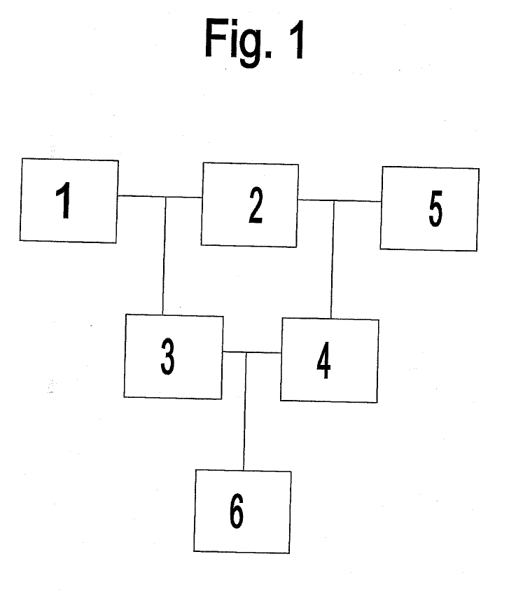

This way, in a vertically painted surface that has to be regulated and painted, FIG. 2, a layer of cement-based paint (7) would be applied directly to a vertical surface (8), with this layer of paint (7) being spread with a toothed sizing trowel (9), while a foam roller (10) would also be used to obtain a stucco finish, and smoothing some of the peaks with a scraper or spatula (11).

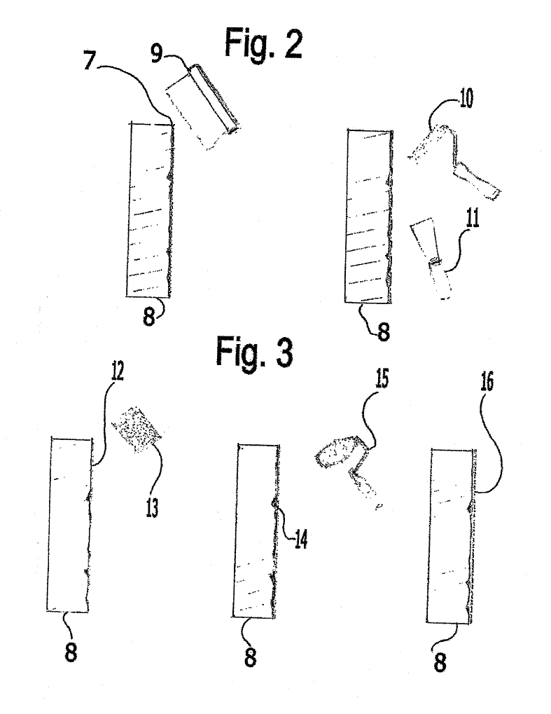

So, with respect to a conventional vertically painted surface as shown in FIG. 3, a layer of regulating putty (12) is applied using a scraper or spatula (11), any unwanted roughness is sanded using abrasive paper (13), the first layer of conventional paint (14) is applied, then a second layer of said paint (16) is applied, with both layers being applied with a synthetic or woollen roller (15).

The putty is omitted and replaced by the layer of paint (7), the sanding (13) is omitted, a layer of paint (16) is omitted, the drying time after each application is omitted, with the consequent time saved in carrying out the task and the implicit cost saving per metre.

What is claimed is:

1. A semi-mineral water-based paint that is virtually inorganic, comprising:
a water-dispersible acrylic copolymer that is elastic and has a low absorption capacity and that is adapted to be mixed with a cement,
an emulsion selected from the group consisting of an acrylic, urethane, vinyl and epoxy alkyd modified emulsion
additives,
an inert reinforcement, filler
colouring pigments, and
a cement base if it is in a liquid state, and water if it is in a solid state,
whereby a manageable paste formed of a putty is obtained that can regulate, paint and decorate at the same time.

2. A semi-mineral water-based paint according to claim 1, wherein the water-dispersible acrylic copolymer that is elastic and has a low absorption capacity is mixed with a cement and is available in one of:
a solid state, and
a liquid state. is preferably mixed

3. A semi-mineral water-based paint according to claim 1, wherein the emulsion selected from the group consisting of an acrylic, urethane, vinyl and epoxy alkyd modified emulsion is available in one of:
a solid state, and
a liquid state.

4. A semi-mineral water-based paint according to claim 1, wherein the additives are available in one of:
a solid state, and
a liquid state.

5. A semi-mineral water-based paint according to the claim 1, the colouring pigments are available in one of:
a solid state, and
a liquid state.

6. A semi-mineral water-based paint according to claim 1, further comprising said cement base.
